(19) United States
(12) Patent Application Publication
(10) Pub. No.: US 2016/0347184 A1
(43) Pub. Date: Dec. 1, 2016

(54) WIRE HARNESS

(71) Applicant: YAZAKI CORPORATION, Tokyo (JP)

(72) Inventor: Hideaki KIKUCHI, Shizuoka (JP)

(21) Appl. No.: 15/163,245

(22) Filed: May 24, 2016

(30) Foreign Application Priority Data
May 29, 2015 (JP) 2015-109565

(51) Int. Cl. B60L 11/10; H02M 3/04; B60L 11/18; H02J 7/16; H02J 7/14

(52) U.S. Cl. CPC B60L 11/10; H02J 7/16; H02J 7/1423; B60L 11/1809; H02M 3/04

(57) ABSTRACT

A wire harness includes a power supply line connected to a single 48 V battery that outputs a 48 V voltage; a power supply control box that receives the 48 V voltage via the power supply line, supplies the 48 V voltage to 48 V loads operating on the 48 V voltage, steps down the received 48 V voltage to provide a 12 V voltage lower than the 48 V voltage, and supplies the 12 V voltage to 12 V loads operating on the 12 V voltage; first supply lines that are provided in between the power supply control box and the 48 V loads to supply the 48 V voltage to the 48 V loads; and second supply lines that are provided in between the power supply control box and the 12 V loads to supply the 12 V voltage to the 12 V loads.

### CROSS-REFERENCE TO RELATED APPLICATION(S)

The present application claims priority to and incorporates by reference the entire contents of Japanese Patent Application No. 2015-109565 filed in Japan on May 29, 2015.

### BACKGROUND OF THE INVENTION

1. Field of the Invention

The present invention relates to a wire harness.

2. Description of the Related Art

Conventionally, 12 V batteries have been installed in vehicles, and various kinds of devices have been operating by electric power from these batteries. In recent years, for the purpose of improving operating performance of devices or the like, introducing devices operating on a 48V voltage into vehicles has been under consideration (refer to Japanese Patent Application Laid-open No. H05-278535).

When incorporating devices operating on the 48 V voltage into a vehicle, it becomes a state in which devices operating on a 12 V voltage and the devices operating on the 48 V voltage are mixedly present. In other words, two batteries, that is, a 12 V battery and a 48 V battery are installed in the vehicle, which is disadvantageous in terms of space. In addition, the number of objects to be controlled such as battery monitoring increases, thereby causing complexity in control. Besides, two kinds of electric wires, that is, an electric wire for the 12 V voltage and an electric wire for the 48 V voltage are required, thereby causing an increase in the number of electric wires.

### SUMMARY OF THE INVENTION

The present invention has been made to solve the above mentioned problems, and an object thereof is to provide a wire harness that can adapt to a state in which devices having different operating voltages are mixedly present, prevent disadvantage in terms of space and an increase in the number of objects to be controlled, and reduce an increase in the number of electric wires.

According to one aspect of the present invention, a wire harness for supplying electric power to various kinds of devices installed in a vehicle, the wire harness includes a power supply line connected to a single vehicle battery that outputs a predetermined first battery voltage; a power supply control box configured to receive the first battery voltage via the power supply line, supply the received first battery voltage to a first device operating on the first battery voltage, step down the received first battery voltage to provide a second battery voltage lower than the first battery voltage, and supply the second battery voltage to a second device operating on the second battery voltage; a first supply line that is provided between the power supply control box and the first device to supply the first battery voltage to the first device; and a second supply line that is provided between the power supply control box and the second device to supply the second battery voltage to the second device.

The wire harness according to the present invention includes the power supply line connected to the single vehicle battery that outputs the predetermined first battery voltage, whereby the power supply control box receives the first battery voltage supplied from the single vehicle battery, supplies the first battery voltage to the first device, steps down the first battery voltage to provide the second battery voltage for the second device operating on the second battery voltage lower than the first voltage, and supplies the second battery voltage to the second device. Consequently, even when the devices having different operating voltages are mixedly present, they can be operated. Furthermore, the single vehicle battery is used for driving these devices, thereby preventing disadvantage in terms of space and preventing the number of objects to be controlled such as battery monitoring from increasing unlike a case in which a plurality of batteries are included. In addition, the first battery voltage is stepped down by the power supply control box to provide the second battery voltage and supply the second battery voltage, whereby although the electric wires for the second battery voltage are required for the second device from the power supply control box, no electric wire for the second battery voltage is required for the vehicle battery from the power supply control box. Consequently, the wire harness according to the present invention can adapt to a state in which devices having different operating voltages are mixedly present, prevent disadvantage in terms of space and an increase in the number of objects to be controlled, and reduce an increase in the number of electric wires.

According to another aspect of the present invention, it is preferable that when the vehicle is divided into a plurality of sections, the power supply control box is provided in one of the sections, sections other than the one section in which the power supply control box is provided include respective sub power supply control boxes configured to receive the first battery voltage via a first connection line and receive the second battery voltage via a second connection line from the power supply control box, the power supply control box supplies voltage to the first device and the second device provided in the one section, and the respective sub power supply control boxes supply voltage to the first device and the second device in the sections in which the respective sub power supply control boxes are provided.

This wire harness includes the power supply control box in one of the sections obtained by dividing the vehicle into the sections, includes the sub power supply control boxes in the other sections, and causes the power supply control box and the sub power supply control boxes in the respective sections to supply voltage to the first device and the second device provided in the respective sections, thereby shortening the electric wires from the power supply control box and the sub power supply control boxes to the first and second device in the respective sections, shortening the electric wires that are required by the number of the devices, and effectively reducing the weight of the wire harness owing to the power supply control box and the sub power supply control boxes provided in the respective sections compared with a case in which only one power supply control box is included. Furthermore, a step-down functional unit is provided only in the power supply control box, thereby eliminating the need to include the step-down functional unit in the sub power supply control boxes and miniaturizing the sub power supply control boxes.

According to still another aspect of the present invention, it is preferable that respective sections obtained by dividing the vehicle into a plurality of sections include the power supply control boxes, and the power supply control boxes in the respective sections supply voltage to the first device and the second device provided in the respective sections.

This wire harness includes the power supply control boxes in the respective sections out of the sections obtained by dividing the vehicle, and the power supply control boxes in the respective sections supply voltage to the first device and the second device provided in the respective sections, thereby shortening the electric wires from the power supply control boxes to the first and second device in the respective sections, shortening the electric wires that are required by the number of the devices, and effectively reducing the weight of the wire harness owing to the power supply control boxes included in the respective sections compared with a case in which only one power supply control box is included. Furthermore, the power supply control boxes are included in the respective sections, thereby reducing the size of the respective step-down functional units and reducing the occurrence of noise along with the stepping down.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a configuration diagram illustrating a power supply system including a wire harness according to a first embodiment of the present invention;

FIG. 2 is a configuration diagram illustrating a power supply system including a wire harness according to a second embodiment; and

FIG. 3 is a configuration diagram illustrating a power supply system including a wire harness according to a third embodiment.

### DETAILED DESCRIPTION OF THE PREFERRED EMBODIMENTS

The following describes the present invention with reference to preferable embodiments. The present invention is not limited to the following embodiments and can be altered appropriately without departing from the essence of the present invention. Although the following embodiments omit illustration and descriptions of partial components, known or well-known techniques are naturally applied to details of omitted techniques appropriately to the extent that there is no inconsistency with details described below.

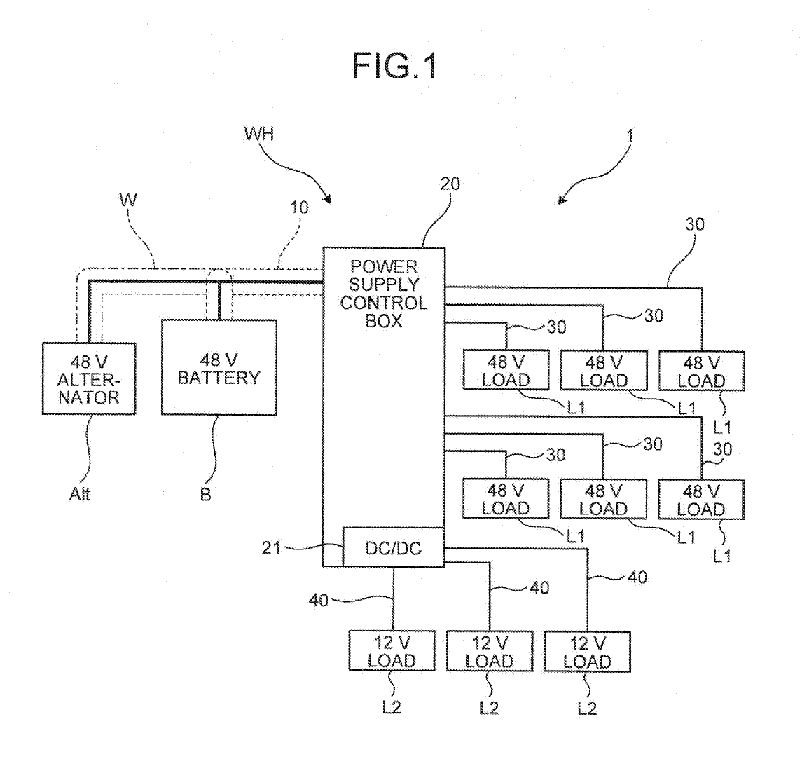

FIG. 1 is a configuration diagram illustrating a power supply system including a wire harness according to a first embodiment of the present invention. As illustrated in FIG. 1, this power supply system 1 is a system that supplies electric power to various kinds of devices provided in a vehicle such as an electric vehicle or a hybrid vehicle and includes a 48 V alternator Alt, a 48 V battery B, and a wire harness WH according to the present embodiment.

The 48 V alternator Alt is a motor for electric vehicles, hybrid vehicles, or the like and functions as an alternator during regeneration. The alternator Alt like this originally generates an alternate current (AC) electricity, which is converted into direct current (DC) via a diode or a rectifier. The 48 V alternator Alt is connected to the 48 V battery B via an electric wire W. With this configuration, electric energy obtained by power generation by the 48 V alternator Alt is charged to the 48 V battery B.

The 48 V battery B is a vehicle battery that outputs a 48 V voltage (a certain first battery voltage) and is constituted by lithium-ion batteries or the like in which a plurality of battery cells are connected in series. In the power supply system 1, only one battery is provided for 48 V loads L1 and 12 V loads L2 described below, and the 48 V battery B is a single battery for driving the loads L1 and L2 described below.

The wire harness WH according to the present embodiment includes a power supply line 10, a power supply control box 20, first supply lines 30, and second supply lines 40 and supplies electric power from the single 48 V battery B to the 48 V loads (first devices) and the 12 V loads (second devices).

The power supply line 10 is a heavy electric wire, for example, one end of which is connected to the 48 V battery B and the other end of which is connected to the power supply control box 20. In the present embodiment, the power supply line 10 may include one type for the 48 V voltage and does not include an electric wire for the 12 V voltage (a second battery voltage).

The power supply control box 20 distributes the received electric power to the various kinds of devices and includes therein a circuit such as various kinds of switching elements, a controller, and the like. The power supply control box 20 receives the 48 V voltage via the power supply line 10 and supplies the received 48 V voltage to the 48 V loads L1 operating on the 48 V voltage. The power supply control box 20 includes a DC/DC converter 21, steps down the received 48 V voltage to provide a 12 V voltage lower than the 48 V voltage, and supplies the 12 V voltage to the 12 V loads L2 operating on the 12 V voltage.

The first supply lines 30 are provided in between the power supply control box 20 and the respective 48 V loads L1 and are conductive members such as electric wires for supplying the 48 V voltage to the 48 V loads L1. The second supply lines 40 are provided in between the power supply control box 20 and the respective 12 V loads L2 and are conductive members such as electric wires for supplying the 12 V voltage to the 12 V loads L2.

In the example illustrated in FIG. 1, the electric power from the 48 V alternator Alt may directly be supplied to the power supply control box 20.

Next, the following describes how power is supplied by the wire harness WH according to the embodiment. First, the 48 V voltage from the 48 V battery B is supplied to the power supply control box 20. The power supply control box 20 then receives the 48 V voltage and supplies the 48 V voltage to the 48 V loads L1 via the first supply lines 30.

The DC/DC converter 21 of the power supply control box 20 steps down the received 48 V voltage to generate the 12 V voltage. The power supply control box 20 supplies the 12 V voltage to the 12 V loads L2 via the second supply lines 40.

The power supply system 1 can thus drive both the 48 V loads L1 and the 12 V loads L2 even by providing only one 48 V battery B.

As described above, the wire harness WH according to the first embodiment includes the power supply line 10 connected to the single 48 V battery B that outputs the 48 V voltage, whereby the power supply control box 20 receives the 48 V voltage supplied from the single 48 V battery B, supplies the 48 V voltage to the 48 V loads L1, steps down the 48 V voltage to provide the 12 V voltage for the 12 V loads L2 operating on the 12 V voltage lower than the 48 V voltage, and supplies the 12 V voltage to the 12 V loads L2. Consequently, even when the loads L1 and L2 having different operating voltages are mixedly present, they can be operated. Furthermore, the single 48 V battery B is used for driving these loads L1 and L2, thereby preventing disadvantage in terms of space and preventing the number of objects to be controlled such as battery monitoring from increasing unlike a case in which a plurality of batteries are included. In addition, the 48 V voltage is stepped down by the power supply control box 20 to provide the 12 V voltage and supply the 12 V voltage, whereby although the electric wires for the second battery voltage (the second supply lines 40) are required for the 12 V loads L2 from the power supply control box 20, no electric wire for the 48 V voltage is required for the 48 V battery B from the power supply control box 20. Consequently, the wire harness WH according to the first embodiment can adapt to a state in which devices having different operating voltages are mixedly present, prevent disadvantage in terms of space and an increase in the number of objects to be controlled, and reduce an increase in the number of electric wires.

Next, the following describes a second embodiment. A wire harness WH according to the second embodiment, which is similar to the first embodiment, is partially different therefrom. The following describes points of difference from the first embodiment.

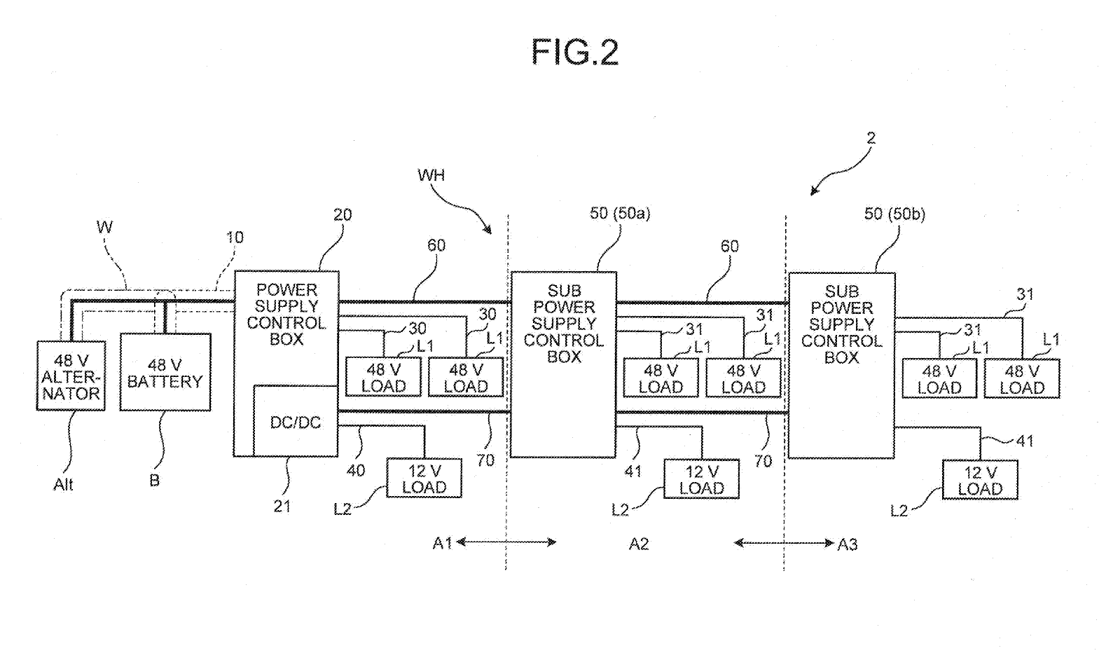

FIG. 2 is a configuration diagram illustrating a power supply system including the wire harness according to the second embodiment of the present invention. As illustrated in FIG. 2, the wire harness WH of this power supply system 2 includes the power supply line 10, the power supply control box 20, the first supply lines 30, and the second supply lines 40, and in addition, sub power supply control boxes 50, a first connection line 60, a second connection line 70, first supply lines 31, and second supply lines 41. The sub power supply control box 50 is an entity obtained by removing the DC/DC converter 21 from the power supply control box 20 and distributes received electric power to various kinds of devices. In the second embodiment, the vehicle is divided into a plurality of sections; or it is divided into three sections A1 to A3, that is, a front section A1, a middle section A2, and a rear section A3, for example. In the second embodiment, the power supply control box 20 is provided in one section A1 of the sections A1 to A3, whereas the sub power supply control boxes 50 are provided in the respective sections A2 and A3 other than the one section A1.

Specifically, the front section A1 includes the 48 V alternator Alt, the electric wire W, the 48 V battery B, the power supply line 10, the power supply control box 20, the 48 V loads L1, the 12 V load L2, the first supply lines 30, and the second supply line 40.

The middle section A2 includes a first sub power supply control box 50a, the 48 V loads L1, the 12 V load L2, the first supply lines 31, and the second supply line 41. Similarly, the rear section A3 also includes a second sub power supply control box 50b, the 48 V loads L1, the 12 V load L2, the first supply lines 31, and the second supply line 41.

Furthermore, the first and second sub power supply control boxes 50a and 50b receive the 48 V voltage via the power supply control box 20 and the first connection line 60 and receive the 12 V voltage via the second connection line 70. The first connection line 60 is a power transmission heavy electric wire for the 48 V voltage, whereas the second connection line 70 is a power transmission heavy electric wire for the 12 V voltage.

The sub power supply control boxes 50 thus receive the 48 V voltage via the first connection line 60 and receive the 12 V voltage via the second connection line 70, whereby electric power can be supplied to the 48 V loads L1 and the 12 V loads L2 via the first supply lines 31 and the second supply lines 41.

The power supply control box 20 in the second embodiment in particular supplies voltage to the 48 V loads L1 and the 12 V load L2 provided in the front section A1, and the sub power supply control boxes 50 supply voltage to the 48 V loads L1 and the 12 V load L2 in the respective sections A2 and A3 in which the sub power supply control boxes 50a and 50b are provided, respectively. This configuration shortens the first supply lines 30 and 31 and the second supply lines 40 and 41 from the power supply control box 20 and the sub power supply control boxes 50 to the 48 V loads L1 and the 12 V load L2 in the respective corresponding sections A1 to A3.

Next, the following describes how power is supplied by the wire harness WH according to the second embodiment. First, power supply by the power supply control box 20 is the same as that illustrated in the first embodiment.

In the wire harness WH according to the second embodiment, the first sub power supply control box 50a receives the 48 V voltage via the first connection line 60. The first sub power supply control box 50a supplies the 48 V voltage to the 48 V loads L1 in the corresponding section A2 via the first supply lines 31. The first sub power supply control box 50a receives the 12 V voltage via the second connection line 70. The first sub power supply control box 50a supplies the 12 V voltage to the 12 V load L2 in the corresponding section A2 via the second supply line 41.

The second sub power supply control box 50b similarly receives the 48 V voltage from the power supply control box 20 via the first connection line 60 with the first sub power supply control box 50a as a relay member. The second sub power supply control box 50b supplies the 48 V voltage to the 48 V loads L1 in the corresponding section A3 via the first supply lines 31. The second sub power supply control box 50b receives the 12 V voltage from the power supply control box 20 via the second connection line 70 with the first sub power supply control box 50a as a relay member. The second sub power supply control box 50b supplies the 12 V voltage to the 12 V load L2 in the corresponding section A3 via the second supply line 41.

As described above, the wire harness WH according to the second embodiment can adapt to a state in which devices having different operating voltages are mixedly present, prevent disadvantage in terms of space and an increase in the number of objects to be controlled, and reduce an increase in the number of electric wires similarly to the first embodiment.

The second embodiment includes the power supply control box 20 in the one section A1 obtained by dividing the vehicle into the sections A1 to A3, includes the sub power supply control boxes 50 in the other sections A2 and A3, and causes the power supply control box 20 and the sub power supply control boxes 50 in the respective sections A1 to A3 to supply voltage to the 48 V loads L1 and the 12 V load L2 provided in the respective sections A1 to A3, thereby shortening the electric wires from the power supply control box 20 and the sub power supply control boxes 50 to the 48 V loads L1 and the 12 V load L2 in the respective sections A1 to A3, shortening the electric wires that are required by the number of the loads L1 and L2, and effectively reducing the weight of the wire harness WH owing to the power supply control box 20 and the sub power supply control boxes 50 included in the respective sections A1 to A3 compared with a case in which only one power supply control box 20 is included. Furthermore, the DC/DC converter 21 (a step-down functional unit) is provided only in the power supply control box 20, thereby eliminating the need to include DC/DC converter 21 in the sub power supply control boxes 50 and miniaturizing the sub power supply control boxes 50.

Next, the following describes a third embodiment. A wire harness WH according to the third embodiment, which is similar to the first embodiment, is partially different therefrom. The following describes points of difference from the first embodiment.

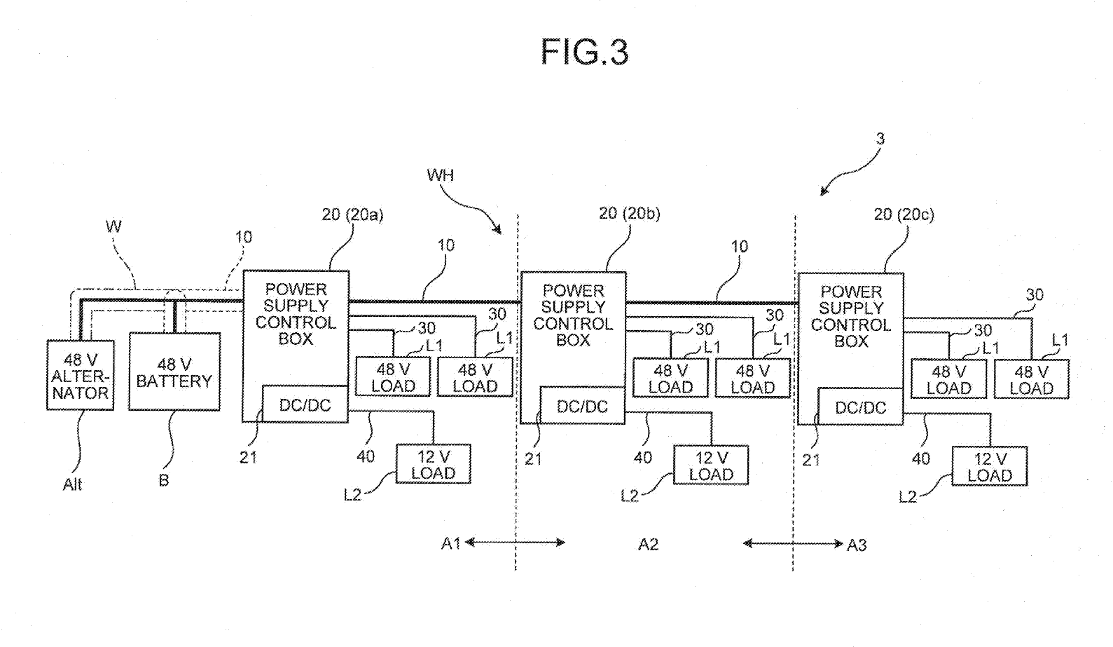

FIG. 3 is a configuration diagram illustrating a power supply system including the wire harness according to the third embodiment of the present invention. As illustrated in FIG. 3, the wire harness WH of this power supply system 3 includes a plurality of power supply control boxes 20. Specifically, in the third embodiment, similarly to the second embodiment, the vehicle is divided into a plurality of sections; or it is divided into the three sections A1 to A3, that is, the front section A1, the middle section A2, and the rear section A3, for example. In the third embodiment, the power supply control boxes 20 are provided in the respective sections A1 to A3, and the power supply control boxes 20 in the respective sections A1 to A3 supply voltage to the 48 V loads L1 and the 12 V load L2 provided in the respective sections A1 to A3.

Furthermore, the power supply line 10 in the third embodiment not only connects the 48 V battery B and a first power supply control box 20a but also is connected to a second power supply control box 20b and a third power supply control box 20c.

Next, the following describes how power is supplied by the wire harness WH according to the third embodiment. Power supply by the first power supply control box 20a is the same as that illustrated in the first embodiment.

In the wire harness WH according to the third embodiment, the second power supply control box 20b receives the 48 V voltage from the 48 V battery B via the power supply line 10 with the first power supply control box 20a as a relay member. The second power supply control box 20b supplies the 48 V voltage to the 48 V loads L1 in the corresponding section A2 via the first supply lines 30. The DC/DC converter 21 of the second power supply control box 20b steps down the received 48 V voltage to generate the 12 V voltage. The second power supply control box 20b supplies the 12 V voltage to the 12 V load L2 in the corresponding section A2 via the second supply line 40.

The third power supply control box 20c similarly receives the 48 V voltage from the 48 V battery B via the power supply line 10 with the first and second power supply control boxes 20a and 20b as relay members. The third power supply control box 20c supplies the 48 V voltage to the 48 V loads L1 in the corresponding section A3 via the first supply lines 30. The DC/DC converter 21 of the third power supply control box 20c steps down the received 48 V voltage to generates the 12 V voltage. The third power supply control box 20c supplies the 12 V voltage to the 12 V load L2 in the corresponding section A3 via the second supply line 40.

As described above, the wire harness WH according to the third embodiment can adapt to a state in which devices having different operating voltages are mixedly present, prevent disadvantage in terms of space and an increase in the number of objects to be controlled, and reduce an increase in the number of electric wires similarly to the first embodiment.

The third embodiment includes the power supply control boxes 20 in the respective sections A1 to A3 out of the sections A1 to A3 obtained by dividing the vehicle, and the power supply control boxes 20 in the respective sections A1 to A3 supply voltage to the 48 V loads L1 and the 12 V load L2 provided in the respective sections A1 to A3, thereby shortening the electric wires from the power supply control boxes 20 to the 48 V loads L1 and the 12 V load L2 in the respective sections A1 to A3, shortening the electric wires that are required by the number of the loads L1 and L2, and effectively reducing the weight of the wire harness WH owing to the power supply control boxes 20 included in the respective sections A1 to A3 compared with a case in which only one power supply control box 20 is included. Furthermore, the power supply control boxes 20 are included in the respective sections A1 to A3, thereby reducing the size of the respective DC/DC converters 21 (the step-down functional units) and reducing the occurrence of noise along with the stepping down.

Although the present invention has been described based on the embodiments, the present invention is not limited to the embodiments; alterations may be made without departing from the essence of the present invention, and other techniques may appropriately be combined to the possible extent.

In the embodiments, the power supply systems 1 to 3 may further include another battery such as an auxiliary battery, not limited to the case in which only one 48 V battery B is included, for example. In this case, the auxiliary battery may be connected to the 48 V loads L1, the 12 V loads L2, or another load. Furthermore, a plurality of wire harnesses WH according to the respective first to third embodiments may be arranged in the vehicle.

The present invention can provide a wire harness that can adapt to a state in which devices having different operating voltages are mixedly present, prevent disadvantage in terms of space and an increase in the number of objects to be controlled, and reduce an increase in the number of electric wires.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness for supplying electric power to various kinds of devices installed in a vehicle, the wire harness comprising:
a power supply line connected to a single vehicle battery that outputs a predetermined first battery voltage;
a power supply control box configured to receive the first battery voltage via the power supply line, supply the received first battery voltage to a first device operating on the first battery voltage, step down the received first battery voltage to provide a second battery voltage lower than the first battery voltage, and supply the second battery voltage to a second device operating on the second battery voltage;
a first supply line that is provided between the power supply control box and the first device to supply the first battery voltage to the first device; and
a second supply line that is provided between the power supply control box and the second device to supply the second battery voltage to the second device.

2. The wire harness according to claim 1, wherein
when the vehicle is divided into a plurality of sections, the power supply control box is provided in one of the sections,
sections other than the one section in which the power supply control box is provided include respective sub power supply control boxes configured to receive the first battery voltage via a first connection line and receive the second battery voltage via a second connection line from the power supply control box,
the power supply control box supplies voltage to the first device and the second device provided in the one section, and
the respective sub power supply control boxes supply voltage to the first device and the second device in the sections in which the respective sub power supply control boxes are provided.

3. The wire harness according to claim 1, wherein
respective sections obtained by dividing the vehicle into a plurality of sections include the power supply control boxes, and
the power supply control boxes in the respective sections supply voltage to the first device and the second device provided in the respective sections.
